(19) United States
(12) Patent Application Publication
(10) Pub. No.: US 2013/0253992 A1
(43) Pub. Date: Sep. 26, 2013

(54) INFORMATION SYSTEM WITH SERVICE-ORIENTED ARCHITECTURE USING MULTIPLE CRITERIA THRESHOLD ALGORITHMS

(71) Applicant: Irina Pyrlina, Heidelberg (DE)

(72) Inventor: Irina Pyrlina, Heidelberg (DE)

(73) Assignee: SAP AG, Waldorf (DE)

(21) Appl. No.: 13/532,461

(22) Filed: Jun. 25, 2012

Related U.S. Application Data
(60) Provisional application No. 61/614,433, filed on Mar. 22, 2012.

(51) Int. Cl. G06Q 10/06

(52) U.S. Cl. 705/7.36

(57) ABSTRACT

A method, a system, and computer-readable medium for processing of data are disclosed. A service-oriented architecture containing a first information system for implementation in an enterprise system can be generated. Efficiency of the first information system is analyzed by comparing the efficiency of the first information system with efficiency of a second information system, wherein the second information system is associated with the service-oriented architecture and performs at least one function performed by the first information system. Based on the analyzing, a more efficient information system for implementation in the service-oriented information system is selected.

### CROSS-REFERENCE TO RELATED APPLICATIONS

The present application claims priority to U.S. Provisional Patent Application No. 61/614,433 to Pyrlina, filed Mar. 22, 2012, and entitled “Information System With Service-Oriented Architecture Using Multiple Criteria Threshold Algorithms,” and incorporates its disclosure herein by reference in its entirety.

### TECHNICAL FIELD

This disclosure relates generally to data processing and, in particular, to service-oriented architecture.

### BACKGROUND

Service-Oriented Architecture (“SOA”) can be a set of principles and methodologies for designing and developing a system along with its software in a form of various interoperable services, which can include business functionalities. SOA can allow consumers of services, e.g., web-based applications, to know what SOA-based services are available. Various computer languages can be used in designing SOA and services that can be associated with it. The design of the SOA can be based on various principles and requirements of the business organization that is implementing the SOA.

SOA can integrate various applications for a Web-based environment and can further use multiple implementation platforms to implement the environment and services. SOA can include an interface that is defined in terms of protocols and functionality. In the SOA, services are loosely coupled with operating systems and other technologies underlying the applications. SOA separates functions into distinct units, or services, which are accessible over a network to allow users to combine and reuse them in the production of applications. These services and their corresponding consumers communicate with each other by passing data in a well-defined, shared format, or by coordinating an activity between two or more services.

Existing SOA initiatives are not able to achieve a desired state of agility for enterprises. In particular, many companies today struggle with unsuccessful SOA implementations. The reason for this is usually the absence of a clearly-defined SOA strategy. The probability of failure in this case is quite high, the same as with an enterprise without a clearly-defined business strategy. Typically, corporate myopia results in chaos and crisis because it is not clear what results must be achieved, what is required to increase profit and where money and resources should be directed to achieve corporate goals and objectives. The same scenario can apply to architecture decision-making when designing a system, where typically value and benefit must be compared against cost and complexity.

### SUMMARY

In some implementations, the current subject matter relates to a computer-implemented method. The method can include generating a service-oriented architecture containing a first information system for implementation in an enterprise system, analyzing efficiency of the first information system by comparing the efficiency of the first information system with efficiency of a second information system, wherein the second information system is associated with the service-oriented architecture and performs at least one function performed by the first information system, and selecting, based on analyzing, a more efficient information system for implementation in the service-oriented information system. At least one of the generating, the analyzing, and the selecting can be performed on at least one processor.

In some implementations, the current subject matter can include one or more of the following optional features. The generating can include analyzing enterprise architecture by assessing business capabilities, business processes, and application capabilities of the enterprise, identifying at least one business service, identifying at least one technical service, and designing, based on the analyzing and identifying of the at least one business service and the at least one technical service, the service-oriented strategy.

In some implementations, identification of at least one business service can include analyzing business service requirement attributes, identifying a list of business services containing the at least one identified business service, designing a service map of business services in the identified list of business services, and identifying at least one business object for use in the at least one business service. Identification of at least one technical service can include performing discovery of the at least one technical service, designing the at least one technical service, and documenting the at least one technical service. Design of the service oriented strategy can include generating documentation describing implementation of service-oriented architecture based on a map of business services.

Analysis of the efficiency of the first information can include ranking the first information system using at least one criteria selected from at least one group of criteria. At least one criteria in the at least one group of criteria can include at least one of the following: internal work and organization of the first information system, at least one policy of the service-oriented architecture, guidelines and change management associated with the service-oriented architecture, readiness of at least one process and business service associated with the service-oriented architecture, and risk management and mitigation associated with the service-oriented architecture. The first information system can be selected as the more efficient information system for implementation in the service-oriented architecture based on the first information system obtaining a higher rank in the at least one criteria than a rank obtained by the second information system in the at least one criteria. Ranking of the first information system can include ranking and classifying at least one error generated by the at least one of the first and second information systems.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary service-oriented architecture approach, according to some implementations of the current subject matter.

FIG. 2 illustrates an exemplary method for designing a service-oriented architecture, according to some implementations of the current subject matter.

FIG. 3 illustrates an exemplary business services clusters map, according to some implementations of the current subject matter.

FIG. 4 illustrates an exemplary classification of services, according to some implementations of the current subject matter.

FIG. 5 illustrates an exemplary service-oriented architecture's documentation, according to some implementations of the current subject matter.

FIG. 6 illustrates an exemplary risk classification, according to some implementations of the current subject matter.

FIG. 7 illustrates an exemplary ranking approach of information system architecture alternatives for implementation in a service-oriented architecture, according to some implementations of the current subject matter.

FIG. 8 illustrates an exemplary system, according to some implementations of the current subject matter.

FIG. 9 illustrates an exemplary method, according to some implementations of the current subject matter.

### DETAILED DESCRIPTION

To address these and potentially other deficiencies of currently available solutions, one or more implementations of the current subject matter provide methods, systems, articles or manufacture, and the like that can, among other possible advantages, provide systems and methods for providing systems, methods, and computer program products for providing an efficient service-oriented architecture design strategy and ranking of information systems associated with the designed service-oriented architecture.

In some implementations, the current subject matter relates to generating a design strategy for a service-oriented architecture (“SOA”) to be implemented in an enterprise. It also relates to ranking of information systems (“IS”) that may be associated with the designed SOA based on various criteria, such as, risk of various errors, where errors can be classified based on various classes or categories (e.g., software errors, human errors, etc.). Such ranking and error classification can allow designers of the SOA to identify risk areas and plan investments needed to eliminate the error flow in case of criticalness or finance of the required change by directing their attention to those systems and errors (or correspondingly risk areas) that are ranked higher than others. Design of the SOA can involve identification of business and technical service that can be of interest to the enterprise and/or its customers. The enterprise and/or its customers can desire to estimate risks of coming into the direction of SOA as a part of decision making process about SOA transfer. As such, it is important that risks are identified early in the process and quickly resolved. Therefore, the error estimation method as a risk estimation backbone can be an important innovation over previous methods and can be of great use for them. The following provides a discussion of the above concepts.

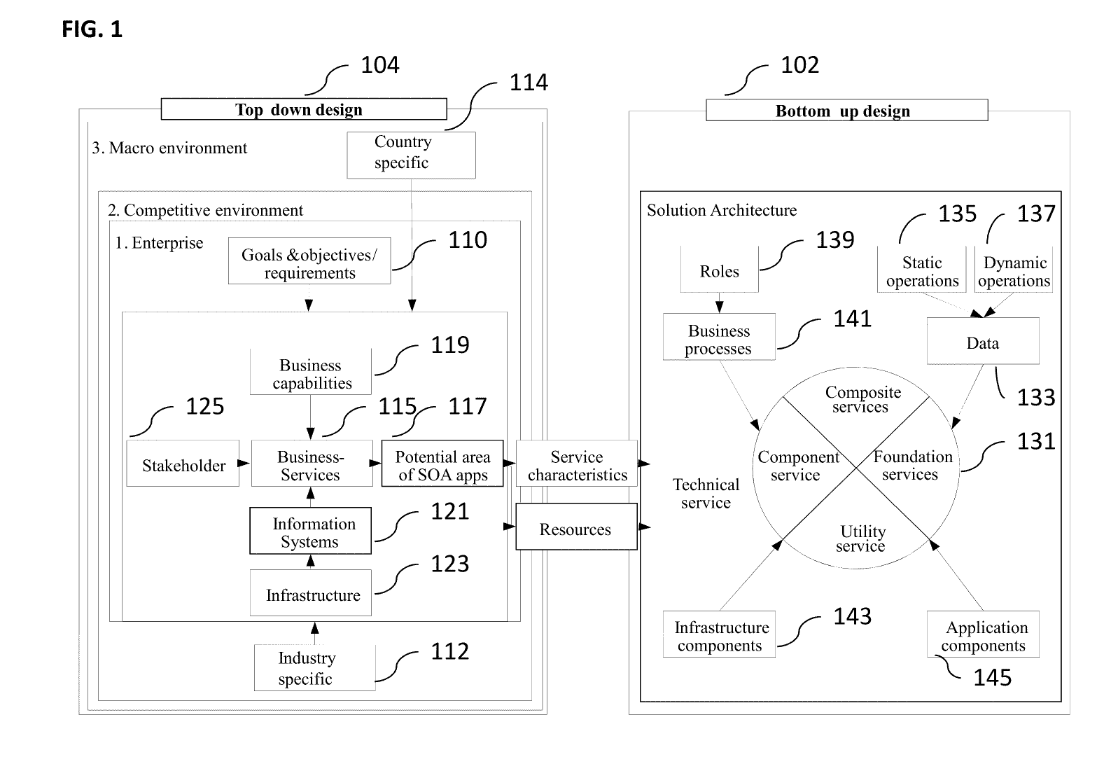

In some implementations, service-oriented architecture can identify web services that support business requirements and then launch them on a technology platform. SOA can include flexible and adaptable business processes and applications as well as organization of services based on the business activities. SOA can be based on business and information technology (“IT”) requirements. The SOA can be implemented using a bottom-up approach 102 and/or a top-down approach 104, as illustrated in FIG. 1. The bottom-up approach assumes understanding of the areas where a service-oriented approach can be applied. A top-down approach emphasizes the areas where SOA can give the most value to the enterprise. Using a combination of these approaches, the SOA application can be designed by determining and/or identifying business services 115 that can be supported by the SOA implementation. The design of the SOA application can be based on creation of information systems that can provide the most value to the enterprise and can be influenced by several factors that can include: enterprise goals and objectives 110, industry-specific factors 112 and country-specific factors 114, as shown in FIG. 1.

An enterprise can include various goals, objectives, and requirements 110 that can influence structure of an enterprise architecture. The enterprise architecture can include business capabilities 119, business service 115, stakeholders (service consumers) 125, areas for SOA implementations 117, information systems 121, and various infrastructure 123. The enterprise architecture can be also influenced by various industry specific factors 112.

The business services 115 and potential areas 117 application of the SOA can include elements relevant to the service model, which can be, for example, functional and non-functional parameters, costs, risks, reusability factors, and others. A map of business capabilities 119 can be used as the basis for identification of business services. Information systems 121 and supporting IT infrastructure 123 can be considered when identifying business services in addition to the goals and objectives of the enterprise and its business capabilities.

A business service can be a combination of functions performed manually, automated operations and systems. It can be characterized by the reusability, number of stakeholders (service consumers) who are interested in the service or capability, discreetness of business services, level of support for business goals and objectives, ability to realize the business service successfully within the organization context, level of complexity of organizational change within the enterprise to realize the business service. A business service can include any combination of people, processes and technology and can be sourced externally or internally.

The map 119 can be used to design applications within the service-oriented architecture as well as specification of technical services 131, which can include the following types: activity level services, entity services, integration services, infrastructure services, composite services and foundation services. The technical services 131 can be provided by various business processes 141 (as identified by their business roles 139), various data 133, infrastructure components 143, and application components 145. Activity level services can be designed from business processes and business functions that can be based on business process steps or lower-level business functions. Entity services can be designed from data entities that can be based on required operations of data entities 133 (which can become service operations). The data entities 133 can include two types of operations: those that view data (static operations 135) and those that change data (dynamic operations 137). Integration services can be designed from and identified through integration points of integration scenarios. Infrastructure services can be designed from and identified through technical components, e.g., through decomposition of supporting infrastructure platform components and their operations. Composite services can be designed and identified through composition points of business processes. Foundation services can include services that already exist and can be stored in the services repository.

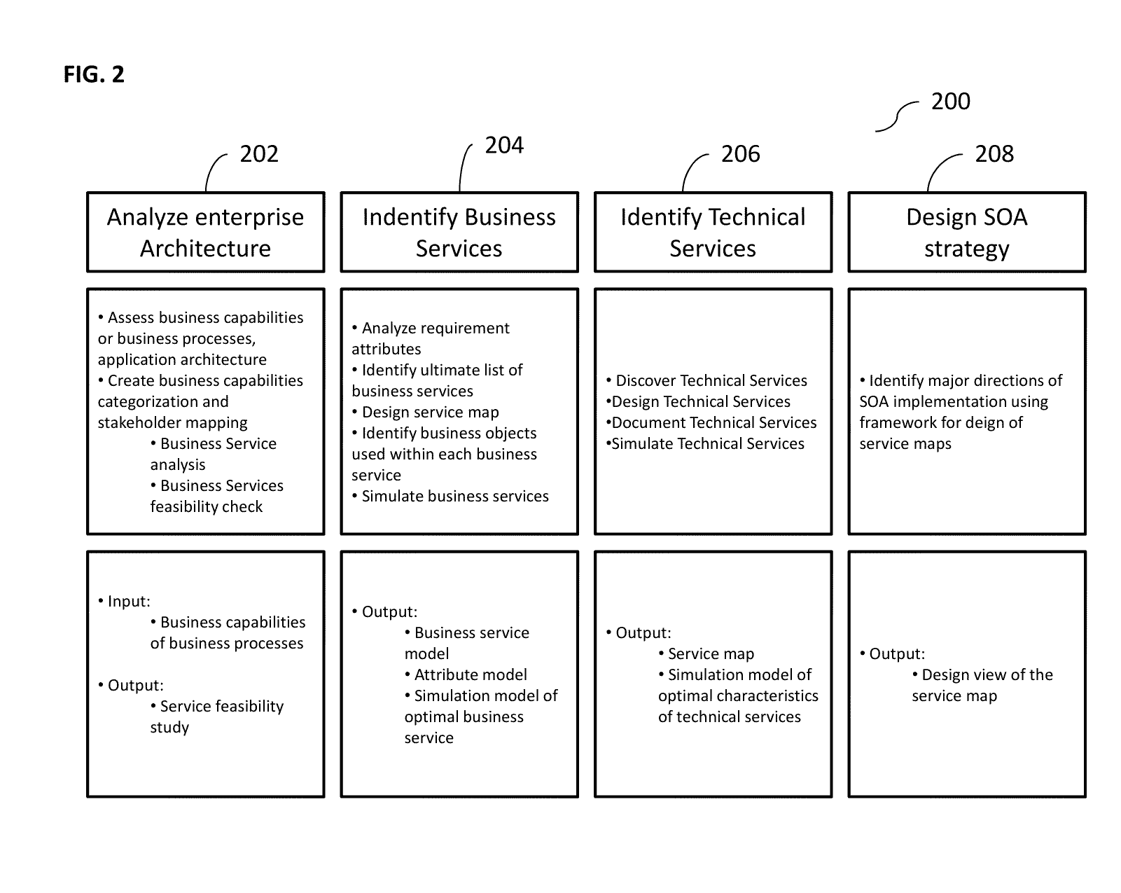

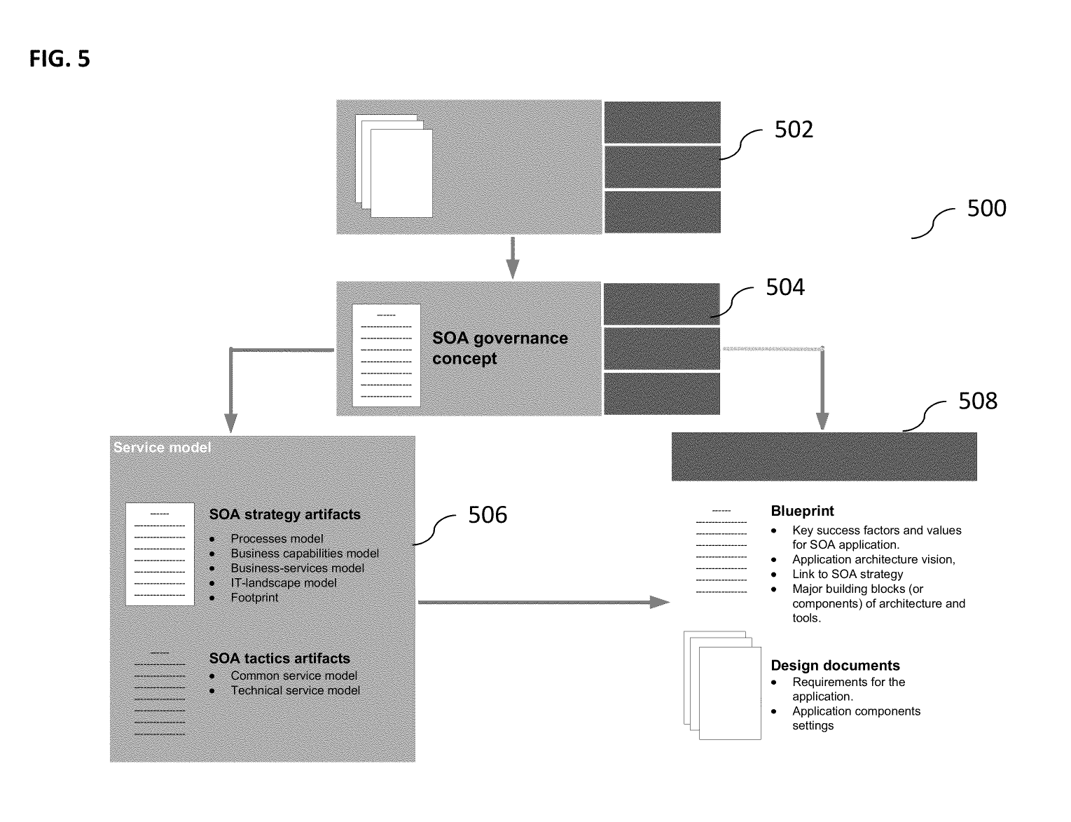

FIG. 2 illustrates an exemplary method 200 for identifying a business service, according to some implementations of the current subject matter. The method 200 can include analyzing enterprise architecture 202, identifying business services 204, identifying technical services 206, and designing an SOA strategy 208. Analysis of enterprise architecture 202 can involve assessment of business capabilities or business processes, application architecture and creation of business capabilities categorization and stakeholder mapping. The mapping can include business service analysis and business services feasibility check. In order to perform this analysis, information about business capabilities of business processes in the enterprise can serve as input information (or “input artifacts”). The output of this phase can be a service feasibility study that can indicate which business services can be implemented. Identification of business services 204 can involve analysis of various requirement attributes of the enterprise, identification of a list of business services, design of a service map of the business services, identification of business objects that can be used within each business service. In some implementations, a simulation of business services can be performed as well. An output of this phase can include a business service model, an attribute model, and a simulation model of optimal business service. Identification of technical services 206 can include discovery of technical services that can be implemented in the enterprise, design of technical services, documentation of technical services, and simulate of technical services. An output of this phase can include a business service map and a simulation model of optimal characteristics of technical services. The design of the SOA strategy 208 can identify major directions of SOA implementation using framework for deign of service maps. An output of this phase can include a design view of the service map along with appropriate documentation (as shown in FIG. 5). Each of the phases 202-208 is discussed further below.

Analysis of the enterprise architecture can determine the scope, focus and goals with regard to business services, at 202 (as shown in FIG. 2). Further, capabilities (or high-level business processes) categorization can be determined based on stakeholders (e.g., enterprise consumers) who are involved in the business process or can take over the whole process. With regard to each stakeholder, various criteria can be assessed: takeover capability (e.g., whether a business service can be outsourced to a particular stakeholder), visibility of the stakeholder (e.g., communication channels that can be provided by the stakeholder to communicate with customers), autonomy of the stakeholder (e.g., whether the stakeholder has all requisite resources), and business goals that are supported by the stakeholder. Additionally, in assessing SOA applicability, business service feasibility criteria can be also assessed. The following criteria can be used to assess the service feasibility:
(1) need to process data and get a result back based on an input (e.g., a result with or without data, feedback from the system, etc.);
(2) need to meet the following:
   a. improve user productivity and ease of use;
   b. enable support for innovative business processes;
   c. increase automation and efficiency of business processes; and
   d. allow more flexibility in deploying an application.
(3) levels of efforts required based on types of applications:
   a. first level—2-tier applications;
   b. second level—3-tier applications with functional modules;
   c. third level—n-tier applications or web-service architecture.

Additional factors can also be taken into account when analyzing enterprise architecture and can include models that can describe a degree of automation (automatic, semi-automatic/dialog and/or manual, etc.), organization units involved in the business capability or business process, models having a hierarchical representation. Further, all relevant stakeholders can be identified, i.e., external business partners (e.g., customers, suppliers, service providers, etc.) and internal business partners (e.g., subsidiaries, other facilities, company headquarters, etc.). Upon completion of the analysis of the enterprise architecture, business services that will be implemented in the SOA can be identified.

As illustrated in FIG. 2, business services can be identified, at 204, by analyzing requirement attributes, identifying ultimate list of business services, designing service map, identifying business objects that can be used within each business service, and simulating business services. When identifying business processes, for each business process step included in the business service, attribute model can be created. An attribute model can be analogous to a network grid that can be composed of various nodes, where each node represents one or more attributes. The attribute model can include several hierarchy levels. The first level can represent an initial core attribute group that can be extracted from business requirements; the second level can identify attribute variations; and the third level can combine all attributes. The network grid can ensure a patterned relationship exists between its descending levels, where each node moving downward can include attribute variations of the previous level. For example, second level can include three nodes that can represent the following attribute combinations: A+B, A+C, and B+C. This node variation can be established based on the previous level. Thus, following this pattern, the bottom level converging node can include all previous attributes.

Forward attribute collection and backward attribute elimination can be used to select most important attributes for business services identification. Forward attribute collection can start from the top core attributes, i.e., at level 1, and proceed downward to select the proper attributes node that best matches business requirements and contributes most to the establishment of business services. Backward attribute elimination can start from the lower levels of the attribution model network and move up toward the first level to enable proper filtering of attributes. The best-chance and second-best-chance attributes can also be identified as more likely fitting the SOA requirements.

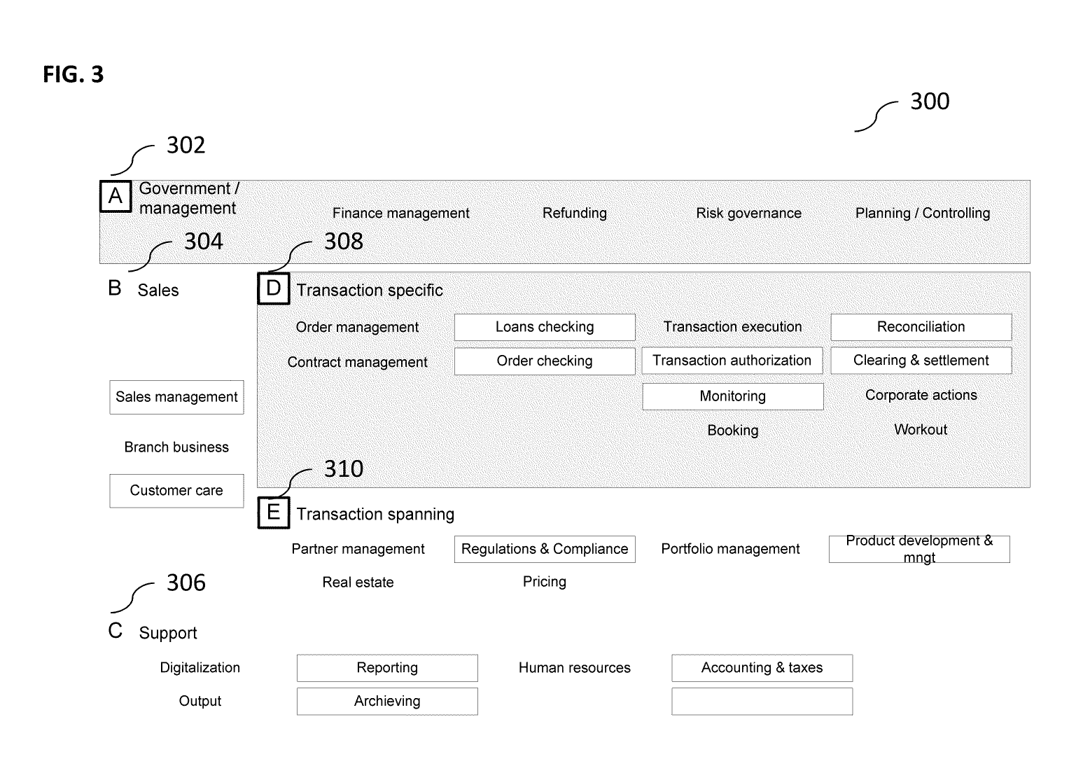

Further, business services can be identified using the identified major attributes (best-chance and second-best-chance attributes) and a decision tree. A decision tree can be built by selecting an attribute set, constructing a conceptual decision-tree structure, prioritizing attributes and completing node positioning, adding more tree nodes and placing the remaining attributes toward the bottom of the decision tree by forming decision levels in which attributes can be classified by their business priorities, establishing business rules, and identifying business services. As soon as business services are identified, they can be grouped into business service clusters. Business objects model can be designed within each identified business service in order to provide an opportunity to create a map of services. An exemplary business service cluster map 300 is illustrated in FIG. 3. The cluster map 300 can include government/management cluster 302, sales cluster 304, support cluster 306, transaction specific cluster 308, and transaction spanning cluster 310. Each cluster can have specific business services. For example, the sales cluster 304 can include sales management, branch business, and customer care business services.

Upon identification of business services to be implemented in the SOA, at least one technical service can be identified, at 206 (as shown in FIG. 2). This involves identification of types of services that will be included in the SOA as well as business drivers. Some exemplary service types include utility, foundation, process, and/or component types and/or any other types. Some example business drivers can include user productivity and centricity, next business practices and process innovation, business automation and process efficiency, flexible deployment and platform, and/or any others. Certain types of services can be correlated with particular types of business drivers. For example, the process and component service types can be best correlated with user productivity and centricity, next business practices and process innovation, and flexible deployment and platform business drivers. Further correlations between drivers and service types can depend on various characteristics of the business drivers and particular requirements and needs of the enterprise.

Based on the correlation between the drivers and service types, the technical services that are to be used in the SOA can be identified using at least one of the following criteria: reusability of a technical service, extensibility of the technical service within the overall architecture, cost of realization, level of complexity of change within the enterprise, e.g., level of process and application change, level of service granularity (e.g., coarser-grained technical services can discourage and/or inhibit reuse, whereas finer-grained technical services can be more difficult to govern and/or manage), ability to use existing technical service standards (e.g., web services, Universal Description, Discovery and Integration (“UDDI”), Web Services Description Language (“WSDL”), etc.), ability to realize the technical service within the technology context, ability of the service to support one or more business processes, ability of the technical service to fall into just one type (or category) of technical service. The technical service can also have a small number of service operations (e.g., not more than 6 service operations).

Additionally, the technical services can have a number of characteristics connected with a quality of service. These can include policies, conditions, and/or rules that can be published for its users (e.g., WS-Policy, WS-PolicyAttachment, WS-PolicyAssertions, WS-SecurityPolicy), safety guidelines that can include rules governing identification, authentication and access control for users that call on such technical services (e.g., WS-Security, WS-SecureConversation, WS-Federation, WS-Authorization, WS-Policy, WS-Trust, WS-Privacy), transactional abilities that can guarantee receipt of results by users of the technical service (e.g., WS-Coordination, WS-Transaction), and control parameters that can be used to control the technical service.

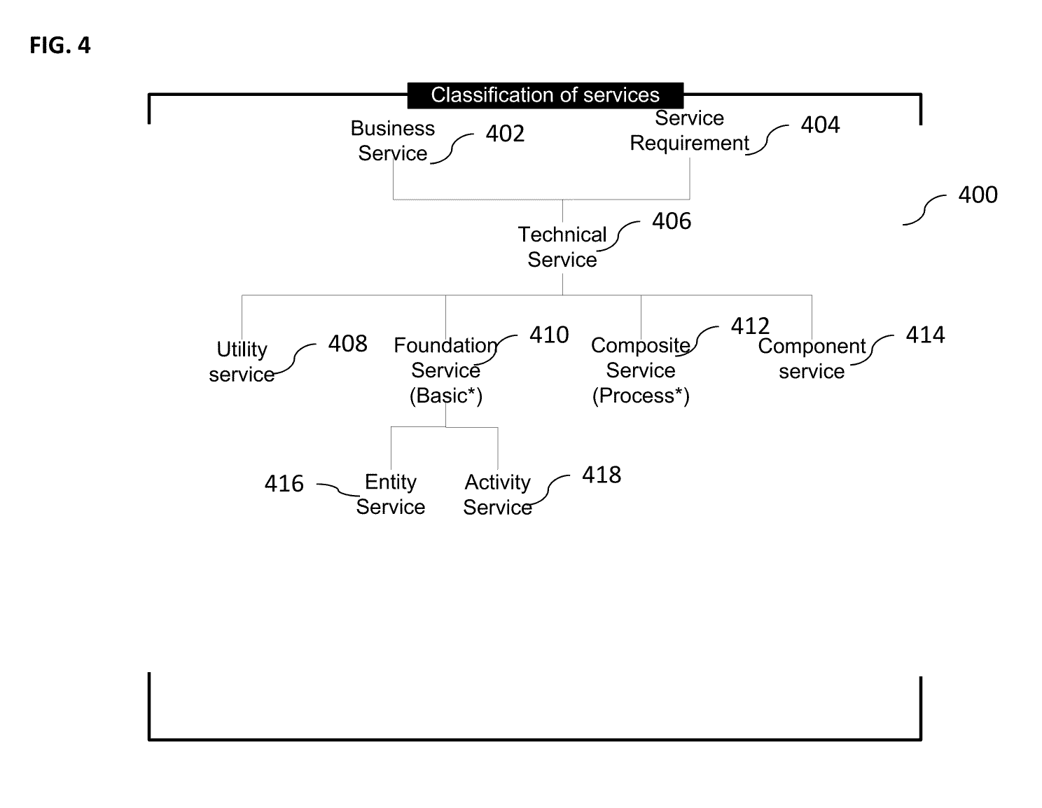

Upon identification of the services, they can be classified, as illustrated in FIG. 4. The services can be classified into business services and technical services. Business services 402 can represent a potential area for application of the SOA. Technical services 406 can be generated based on the business services 402 reflecting the SOA strategy or from a particular business requirement 404. Technical services 406 can include a foundation service 410, a utility service 408 that can perform some commonly used functionality, such as, an authorization check or an input check for other services or for consumers of services, a composite service 412, and a component service 414 that can be the most complex type of service which can combine operations that keep track of relationships, data access and external information. Foundation service 410 can be used as an atomic service for design and implementation of various SOA applications. Foundation services can include: entity services 416 (e.g., services that can operate with and designed from entities or data objects) and activity services 418 (e.g., services that can be designed from special operations). Entity services 416 can have several standard service operations such as CRUD (create, read, update and delete) operations in case standard entity and search, archive or distribute operations additionally in case of master data entities.

Once the design of the business service map is completed, the top-down or bottom-up approaches can be used to design technical services. Use of the top-down approach can involve detailing a business service and identify a number of technical services for each business service on the basis of process decomposition. For each business service, types of technical services used can be recommended on the basis of use of the driver-service type mapping and information gathered for identification of business service (i.e., business driver). Use of the bottom-up approach can mean that the detailed process analysis can be performed first, then technical services can be identified based on the process requirements and types of technical services.

When business services and technical services are identified and appropriately classified, the SOA strategy can be devised, at 208 (as shown in FIG. 2). The strategy can be designed using business capabilities of the enterprise, a model identifying service capabilities, correlation between service capabilities and business services along with corresponding service clusters, a business services map and service cluster map, as well as the details of technical services designed for concrete business services. FIG. 5 illustrates an exemplary documentation 500 that can be generated upon completion of the design of the SOA strategy. The “SOA strategy” documentation 502 can describe all decisions relating to SOA's use, including goals, detailed benefits, the SOA roadmap, and basic methods and tools for the implementation of SOA. This document can incorporate the approach used for identification of SOA strategy. The “SOA governance concept” documentation 504 can contain the main governance element of this approach, including methods and organizational measures. The “Service Model” documentation 506 can contain all artifacts which describe the SOA strategy and tactics, including process models, business capability models, business service models, service maps, technical service models. The “Solution Architecture” documentation 508 can describe solution architecture concept, e.g., blueprints and design documentation.

Once the SOA architecture has been devised, the efficiency of information systems (“IS”) associated with the SOA architecture can be evaluated by ranking various criteria, including IS internal work and organization, SOA policies, guidelines and change management, processes and business services readiness, risk management and mitigation. In order to choose the most efficient IS, multiple criteria threshold algorithm can be implemented. Each category of criteria includes a set of parameters that can be used to determine ranking risk of a particular IS, as discussed below. Using this algorithm, quality criteria for service-oriented architecture can be defined. Each criterion can be ranked using 4 grades which can show either priority (“very high”, “high”, “medium”, “low”), or maturity level of business service (“best”, “good”, “medium”, “painful”), or automation level (30%, 50%, 70%, 100%). The analysis can be performed within each category to aggregate criteria assessments, then the procedure can be repeated to obtain final aggregated and ranked values for each proposed IS.

The risks associated with a particular IS associated with a service-oriented architecture can be determined based on risk classification and errors associated with the evaluated IS. The risk can be classified as follows: input-output errors (I/O or user interface risks), functional risks, middleware risks, data risks, system risks, and/or any other risks, where each of the risks/errors have various priorities as indicated above.

Internal work and organization of IS with service-oriented architecture can correspond to a quality of application architecture, process management, usage of key SOA principles for data, service and application management. These criteria can be characterized by a level of service platform existence, high availability of services, level of flexibility and scalability of SOA-platform, and readiness of existing application to consume and provide services. Level of service platform existence can be measured by the availability of required and sufficient platform components, which meet the SOA definition. The following components can be evaluated: readiness of platform for people integration, readiness of platform to connect information sources and receivers to technical services, readiness of platform to consume services and to connect processes to technical services, and/or readiness of development platform to change, maintain technical services. Ranking can be assigned per level of availability of listed criteria accordingly and can be defined based on availability of at least one platform component. The more components are available, the higher the ranking of the IS system.

High availability of services can indicate that concepts that describe how to make technical service highly available from the business perspective and how to deal with a non-available service are already in place. Services in the SOA can provide high level of readiness, availability and visibility between service-provider and a service-consumer. Service readiness can depend on relationships between service-provider and service-consumer. Service availability can depend on a level of connection between service participants and quality of communication channel. Service availability can be graded based on a level of service readiness and accessibility as follows: grade 1 can indicate a low level of service-consumers notification, low readiness and accessibility; grade 2 can indicate publication of service requests, medium readiness and accessibility; grade 3 can indicate sending of notification about services, high readiness and accessibility; and grade 4 can indicate using a unified repository to manage service relationships with consumers, very high readiness and accessibility.

The level of flexibility and scalability of SOA-platform can be oriented on the following aspects: configuration from the performance point of view, support of different service availability levels, capabilities to meet the needs of changing business requirements especially from higher requirements of service level agreement (“SLA”) and load increase. The following ranking approach can be used: (1) low platform flexibility and scalability, (2) medium platform flexibility and scalability, (3) high platform flexibility and scalability, and (4) very high platform flexibility and scalability.

Readiness of existing applications to consume and provide services can be defined according to the level of customization and development needed to adopt current applications to define and implement services. The following ranking approach can be used: (1) high customization and development effort required for all systems, (2) medium effort for all or for several systems, (3) IT landscape contains the systems providing services, (4) all systems are ready to provide and consume services.

The SOA policies, guidelines and change management can include measures used to adopt SOA in enterprise and to control the operations. This category can check availability of SOA governance policies and verify the change management activities to adopt SOA. The SOA guidelines, policies and change management can be ranked based on a level of service reusability in the IT landscape, service design capabilities, capabilities to support high service availability, change management for services provider, and service level.

The level of services reusability in the IT landscape can depend on the methods and procedures for adopting existing processes to new way of systems design. The ranking approach can be as follows: (4) the level of service reuse is more than 40%, (3) the level of service reuse is around 20%-40%, (2) the level of service reuse is around 10%-20%, (1) the level of service reuse is around 0%-10%.

Service design capabilities can measure the knowledge and expertise level required for service management, service requests processing and service applications change. In other words, the criteria can check whether experts know the methods to orchestrate and redesign services. The ranking approach can be as follows: (4) very high expertise level and enough experts available, (3) high expertise level, (2) medium expertise level, (1) low expertise level.

Capabilities to support high service availability can depend on the experts' availability and platform support. Ranking approach can be as follows: (4) very high capacity and support level, (3) high capacity and support level, (2) medium capacity and support level, (1) low capacity and support level.

Change management for service provider can define readiness level of service provider, capabilities to offer business process and technical services to different (internal) customers at different service levels. Ranking approach can be as follows: (4) very high level of service provider flexibility and reliability, (3) high level of reliability, (2) medium level of reliability, (1) low level of reliability.

Service level agreement can define a level of service agreement preparation and can further define quality, performance and response time. Ranking approach can be as follows: (4) availability of SLA with control system, penalties and incentives, (3) availability of SLA with partial control, (2) partly defined SLA, (1) absence of SLA.

Readiness of process and business services can define a level of process standardization, readiness and availability of service identification methods and regulations to support SOA requirements coverage and further adoption of SOA in the enterprise. Readiness of process and business services can be ranked based on service governance processes, master data compliance level, level of transaction data compliance, and version control.

Service governance processes can control existence of governance processes to identify benefits in standardization, reusable granularity, cutting and designing the processes accordingly. Holistic life-cycle management for processes and services can also be accounted for. Ranking approach can be as follows: (4) governance on the project portfolio level, (3) governance board level, (2) separate service governance on the line of business, (1) partly governed.

Master data compliance level can define the level of common and harmonized view for all master data objects across all systems. To simplify the service-oriented architecture adoption, the master data can have a common, unified view on business partners, materials, employees, organizational units and other data objects. Ranking approach can be as follows: (4) very high level of data compliance, (3) high level of data compliance, (2) medium level of data compliance, (1) low level of data compliance.

Transactional data compliance can be ranked as follows: (4) very high level of data compliance, (3) high level of data compliance, (2) medium level of data compliance, (1) low level of data compliance.

Version control of process steps can relate to processing of change control and version management. It can describe how to feed a business process (parameters) and what to expect from a business process. Versioning approach can depend on how stable the versions of process steps are. Ranking approach can be as follows: (4) absence of process change and high service granularity, (3) rare process change and low service granularity, (2) often process change and low service granularity, (1) absence of version control.

Operational risks can be defined as potential losses from errors of SOA implementation in the enterprise. Minimization of operational risk can check potential operational risks from errors of information system work with SOA. Risk analysis can be provided on the basis of classification approach and statistics. The ranking approach can be as follows: (1) low risk, (2) medium risk, (3) high risk, (4) very high risk.

The rankings criteria can then be used to determine quality for an analyzed SOA. Two approaches can be used to do so: multiple criteria threshold approach and/or maximin approach.

Multiple criteria threshold approach can be based on final ranking of criteria categories with four grades. Values can be aggregated per category first and then the procedure can be repeated a second time for resulting values to get the final ranking Aggregation can be made according to a threshold rule. Binary relationships can be generated by this threshold rule and can define preferences for a variety of SOA projects. The set of projects with service-oriented architecture can be evaluated using identified criteria. Every project can receive a grade for every criteria using four-grade scale. The threshold rule can be as follows:

$${W}_{tr} = \{ ( x , y ) \vert [ {v}_{1} ( x ) < {v}_{1} ( y ) ] or [ {v}_{1} ( x ) = {v}_{1} ( y ) and {v}_{2} ( x ) < {v}_{2} ( y ) ] or [ {v}_{1} ( x ) = {v}_{1} ( y ) and {v}_{2} ( x ) = {v}_{2} ( y ) and {v}_{3} ( x ) < {v}_{3} ( y ) ] \} ,$$

where v₁(x)—the multiplicity of grade one (“1”) in vector x, v₂(x)—correspondingly multiplicity of grade two (“2”), and v₃(x)—multiplicity of grade three (“3”). The relation Wₜᵣ can represent a set of binary pairs of vectors for which either first vector has less multiplicity of grade one rather than second or they have equal multiplicity of grade one and less multiplicity of grade two for first vector, or they have equal multiplicity of grades one and two, and less multiplicity of grade three for first vector. As a result the vectors can be ranked.

For example, in case of four grades and three criteria to compare the whole set of vectors can include at least some of the following groups: {1,1,1} corresponding to all criteria having “low” grades; {2,1,1}, {1,2,0}, {1,1,2} corresponding to all criteria except one with grade “2”, having “low” grades; . . . ; {4,4,4) corresponding to all criteria having “very high” grades.

Assuming that K is a number of equivalence classes, then K can be represented as

$$K = \frac{( n + 3 ) ( n + 2 ) ( n + 1 )}{6}$$

where n is a number of criteria within the category. As a result, the enumerating scale can be generated, which is reflected in the segment [0,1]. As an aggregated value of IS category, the following values can be used

$$v = \frac{i - 1}{k} ε [ 0 , 1 ]$$

where i—index of equivalence class.
As a result aggregation formula in case of 4 ranks looks like following:

$$Φ ( x ) = {\sum }_{j = 1}^{2} {C}_{n - {V}_{j} ( x ) + 3 - j}^{4 - j} + {V}_{4} ( x ) + 1 = {\sum }_{j = 1}^{2} \frac{( n - {V}_{j} ( x ) + 3 - j ) !}{( 4 - j ) ! ( n - {V}_{j} ( x ) ) !} + {V}_{4} ( x ) + 1$$

$$Φ ( x ) = \frac{( n - {V}_{1} ( x ) + 1 ) ( n - {V}_{1} ( x ) + 2 )}{6} + \frac{n - {V}_{2} ( x ) + 1}{2} + {V}_{4} ( x ) + 1 ,$$

where n—number of analyzed criteria for comparison of different options of information system architecture,

Cₖ^{k+1}=0 for all k∈[0,m−1] and C₋₁⁰=1.
Aggregation formula in case of 5 ranks looks like following:

$$Φ ( x ) = {\sum }_{j = 1}^{3} {C}_{n - {V}_{j} ( x ) + 4 - j}^{5 - j} + {V}_{5} ( x ) + 1 = {\sum }_{j = 1}^{3} \frac{( n - {V}_{j} ( x ) + 4 - j ) !}{( 5 - j ) ! ( n - {V}_{j} ( x ) ) !} + {V}_{5} ( x ) + 1 ,$$

where n—number of analyzed criteria for comparison of different options of information system architecture,

Cₖ^{k+1}=0 for all k∈[0,m−1] and C₋₁⁰=1.

Alternatively, risks can be ranked using a maximin approach based on the following rule:

construct a matrix S+ such that,

∀x,y∈A,S⁺={n(x,y)}

where n(x, x)=+∞, A—project set and n(x,y)={1|P₁(x)>P₁(y)}.

Thus, n(x,y) can be located at the intersection of row X and column Y in the matrix S+, where n(x,y) can be equal to the number of criteria in which alternative X has higher values than alternative Y taking into account the measurement error. Alternatives X and Y can correspond to compared projects and n(x,y) can correspond to a number of criteria used to compare risk types. In this approach, row minima can be chosen from every row in the matrix (i.e., for every alternative) and the highest value can be chosen from the identified minimum values. Final “maximin” value (i.e., risk category) can represent the highest rank. This procedure can be repeated for all other risk types. Thus, the maximin rule can be presented as follows x∈C₁(A) if and only if

n(x,y)=_{a∈A}^{max}{_{b∈A}^{min}{n(a,b)}}

for some y x, y∈A.

In some implementations, the operational risks of information systems associated with service-oriented architecture can be classified into various risk categories and system error categories. Operational risks in the SOA based information systems can be tied with errors in resources used by these systems, for instance with resources of business services. Human resources, software resources, and technical resources are such exemplary system resources. Human resources can be employees participating in the process or service. These can include line of business (“LoB”) representatives, experts responsible for key service operations, process and data owners, authors of requests, as well as administrators of service applications. Software resources can be systems which have a possibility to provide/support technical services, which can include not only business applications but also system software. Some examples of software resources can include access modules that can include diverse types of user interfaces for system activities, software or applications that can include a mathematical mechanism of the system, middleware that can be used to organize data exchange among applications and modules, and system software that can include applications which support and control server operations. Technical resources can be hardware to support and store system resources.

Based on the resources classes, the following operational risk types can be identified: personnel risks that can include risks of losses from unauthorized, inaccurate or inappropriate work of personnel; software risks that can be defined as risks of losses from software components failure; technical risks that can represent risks from hardware disruption.

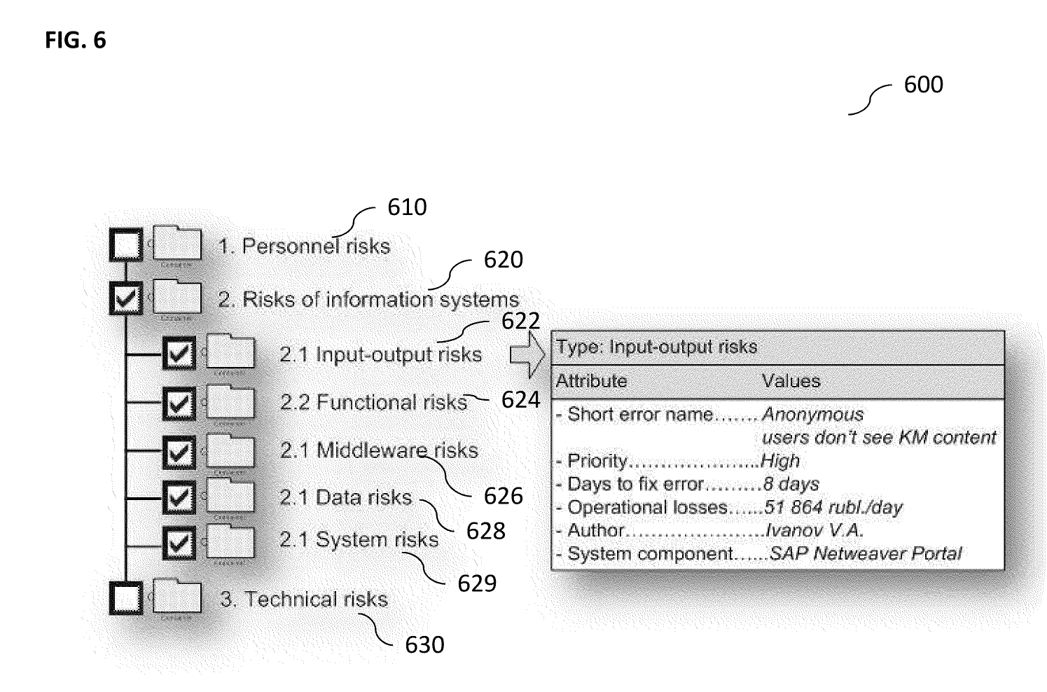

FIG. 6 illustrates an exemplary classification of risks 600 of an information system in a service-oriented architecture, according to some implementations of the current subject matter. The risks can include personnel risks 610, risks of information systems 620, and technical risks 630. The risks of information systems 620 can include input-output risks 622, functional risks 624, middleware risks 626, data risks 628, and system risks 629. An example of the input-output risk 622 can have various attributes and values associated with respective attributes. As shown in FIG. 6, the attributes can include a “Short error name” (having an exemplary value of “Anonymous users don't see KM content”), “Priority” (having an exemplary value of “High”), “Days to fix error” (having an exemplary value of “8 days”), “Operational losses” (having an exemplary value of “51,864 rubles/day”), “Author” (having an exemplary value of “Ivanov V. A.”), and “System component” (having an exemplary value of “SAP Netweaver Portal”). Other attributes and values corresponding to the risks shown in FIG. 6 are possible. The errors associated with the risks can be also ranked as discussed herein.

Software risks can be derived from software errors losses. Software errors can be defined as results of system activities that are not achieved or any deviation from forecasted output of the system. Software errors can include any defects identified during system execution and data input, incorrect system output, incorrect activities of personnel which result in incorrect output. Software errors can be classified based on a priority and level of impact, application type, error reasons, and place of software lifecycle. Priority and level of impact can have the following types: very high priority, high priority, medium priority, and low priority. The application type can include: user interface errors, application errors, middleware errors, system errors, and hardware errors. Error reasons can include: functional errors, system errors, process errors, data errors, code errors, documentation errors, and other errors, where the reason cannot be identified;

The SOA system errors and operational risks can be classified into three classes: main class, priorities, and duration. The main class of errors can include input-output errors (I/O or user interface errors) that stand for errors in constant values or variables, and errors of input or output data; functional errors in system code, or processing logic where transformation of input data is done, middleware errors that contain data exchange problems between different applications, distortion of the data during the transfer or errors in message exchange, data errors that represent errors of data change in any system component or data storage, system errors software including server configuration errors, user access errors, productivity problems, operation system failure and hardware failure, and errors during installation and support of the system, and other errors that can be fixed without customization change or code modification. The error priorities class can be maintained as follows: very high (1) errors that can have high business impact or effect on productive system operations, critical for core processes or function execution that result in failure of critical system, high priority (2) errors that can have considerable effect on the systems and business processes and result in visible productivity decrease, medium priority (3) errors that can have an effect on system functionality and correspondingly can influence business operations, however they are not critical for the business, and low priority (4) errors (e.g., user interface errors that do not prevent system use, however, they are inconvenient for users and should be fixed). Duration of error fixing can be a class for weighing complexity of error which can be estimated according to the time required to fix it. The duration can be counted from the creation date of the error message to the date when the customer confirms the problem is fixed, i.e., the date when its status can be changed to “confirmed”.

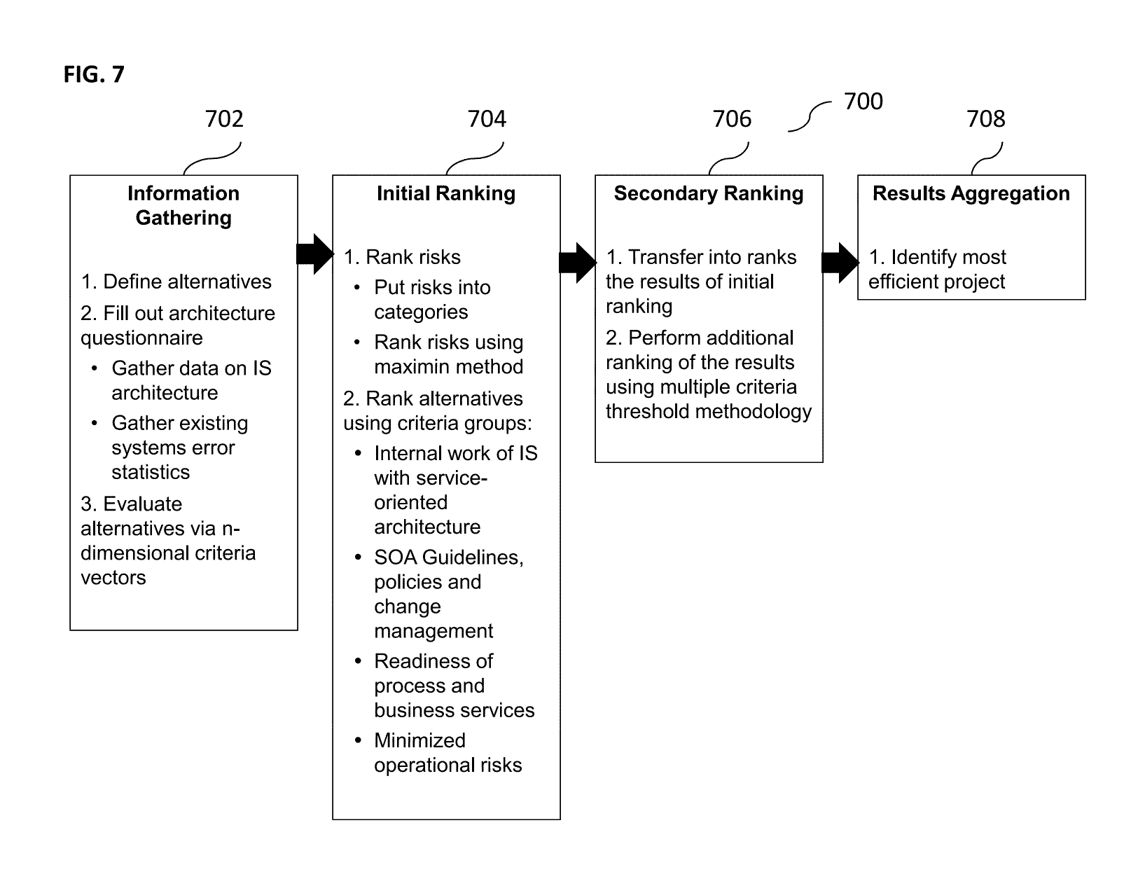

FIG. 7 illustrates an exemplary process 700 for ranking risks associated with implementation of various information system architectures, according to some implementation of current subject matter. At 702, information about information system architectures can be gathered. This can include determining and/or obtaining definitions of various information system architecture alternatives, completing or filling out questionnaires concerning information systems architectures, and evaluation of the alternatives using n-dimensional vectors (e.g., using criteria discussed above). During completion of questionnaires, various data can be gathered on the information system architecture alternatives as well as error statistics for existing systems can be obtained.

At 704, initial ranking of risks associated with the information system architecture alternatives can be performed. This can be done using any number of categories (e.g., five categories) and the maxmin ranking (as discussed above) of such risks can be applied to determine high and/or low risks associated with such categories. Further, based on the identified criteria, the information system architecture alternatives can be ranked. Such ranking can be implemented in groups, which can include: internal organization of information system within SOA group, SOA guidelines, policies, and change management group, readiness of process and business services group, and minimized operational group.

At 706, secondary ranking of information system architecture alternatives can be performed. This can include transferring or obtaining results the initial ranking 704 and performing additional ranking of such results using multiple criteria threshold methodology (discussed above). At 708, based on the results of the secondary ranking 706, most efficient information system architecture alternative (or project) can be identified for implementation.

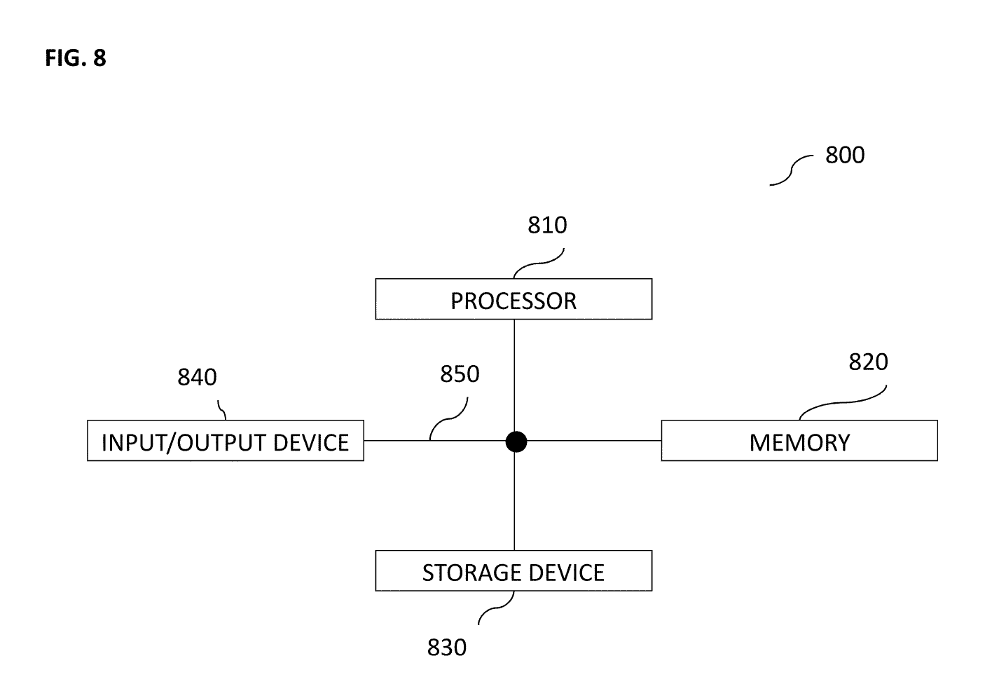

In some implementations, the current subject matter can be configured to be implemented in a system 800, as shown in FIG. 8. The system 800 can include a processor 810, a memory 820, a storage device 830, and an input/output device 840. Each of the components 810, 820, 830 and 840 can be interconnected using a system bus 850. The processor 810 can be configured to process instructions for execution within the system 800. In some implementations, the processor 810 can be a single-threaded processor. In alternate implementations, the processor 810 can be a multi-threaded processor. The processor 810 can be further configured to process instructions stored in the memory 820 or on the storage device 830, including receiving or sending information through the input/output device 840. The memory 820 can store information within the system 800. In some implementations, the memory 820 can be a computer-readable medium. In alternate implementations, the memory 820 can be a volatile memory unit. In yet some implementations, the memory 820 can be a non-volatile memory unit. The storage device 830 can be capable of providing mass storage for the system 800. In some implementations, the storage device 830 can be a computer-readable medium. In alternate implementations, the storage device 830 can be a floppy disk device, a hard disk device, an optical disk device, a tape device, non-volatile solid state memory, or any other type of storage device. The input/output device 840 can be configured to provide input/output operations for the system 800. In some implementations, the input/output device 840 can include a keyboard and/or pointing device. In alternate implementations, the input/output device 840 can include a display unit for displaying graphical user interfaces.

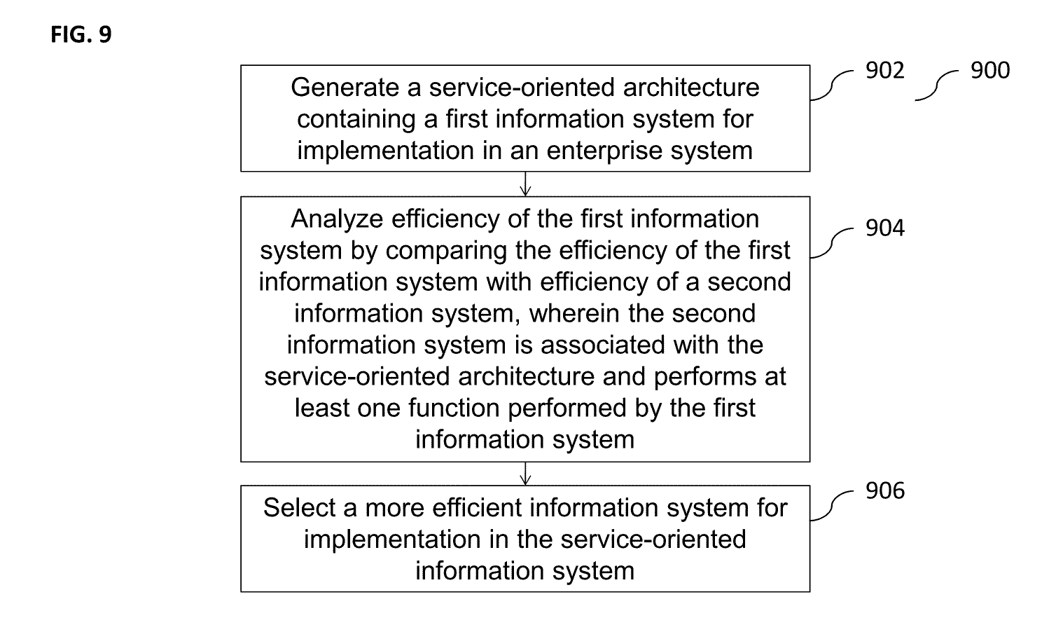

FIG. 9 illustrates an exemplary method, according to some implementations of the current subject matter. At 902, a service-oriented architecture containing a first information system for implementation in an enterprise system can be generated. At 904, an efficiency of the first information system can be analyzed by comparing the efficiency of the first information system with efficiency of a second information system. The second information system can be associated with the service-oriented architecture and can perform at least one function performed by the first information system. At 906, a more efficient information system for implementation in the service-oriented information system can be selected based on the analysis. At least one of the generating, the analyzing, and the selecting can be performed on at least one computer.

The current subject matter can include at least one of the following optional features. The generating can include analyzing enterprise architecture by assessing business capabilities, business processes, and application capabilities of the enterprise, identifying at least one business service, identifying at least one technical service, and designing, based on the analyzing and identifying of the at least one business service and the at least one technical service, the service-oriented strategy. Identification of at least one business service can include analyzing business service requirement attributes, identifying a list of business services containing the at least one identified business service, designing a service map of business services in the identified list of business services, and identifying at least one business object for use in the at least one business service. Identification of at least one technical service can include performing discovery of the at least one technical service, designing the at least one technical service, and documenting the at least one technical service. Design of the service-oriented strategy can include generating documentation describing implementation of service-oriented architecture based on a map of business services.

Analysis of the information systems can include ranking the first information system using at least one criteria selected from at least one group of criteria. At least one criteria in the at least one group of criteria can include at least one of the following: internal work and organization of the first information system, at least one policy of the service-oriented architecture, guidelines and change management associated with the service-oriented architecture, readiness of at least one process and business service associated with the service-oriented architecture, and risk management and mitigation associated with the service-oriented architecture. The first information system can be selected as the more efficient information system for implementation in the service-oriented architecture based on the first information system obtaining a higher rank in the at least one criteria than a rank obtained by the second information system in the at least one criteria. Ranking can also include ranking and classifying at least one error generated by the at least one of the first and second information systems.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
generating a service-oriented architecture containing a first information system for implementation in an enterprise system;
analyzing efficiency of the first information system by comparing the efficiency of the first information system with efficiency of a second information system, wherein the second information system is associated with the service-oriented architecture and performs at least one function performed by the first information system; and
selecting, based on analyzing, a more efficient information system for implementation in the service-oriented information system;
wherein the at least one of the generating, the analyzing, and the selecting is performed on at least one processor.

2. The method according to claim 1, wherein the generating further comprises analyzing enterprise architecture by assessing business capabilities, business processes, and application capabilities of the enterprise;
identifying at least one business service;
identifying at least one technical service; and
designing, based on the analyzing and identifying of the at least one business service and the at least one technical service, the service-oriented strategy.

3. The method according to claim 2, wherein the identifying the at least one business service further comprises
analyzing business service requirement attributes;
identifying a list of business services containing the at least one identified business service;
designing a service map of business services in the identified list of business services; and
identifying at least one business object for use in the at least one business service.

4. The method according to claim 2, wherein the identifying the at least one technical service further comprises
performing discovery of the at least one technical service;
designing the at least one technical service; and
documenting the at least one technical service.

5. The method according to claim 2, wherein the designing of the service oriented strategy further comprises generating documentation describing implementation of service-oriented architecture based on a map of business services.

6. The method according to claim 1, wherein the analyzing further comprises
ranking the first information system using at least one criteria selected from at least one group of criteria;
wherein the at least one criteria in the at least one group of criteria includes at least one of the following: internal work and organization of the first information system, at least one policy of the service-oriented architecture, guidelines and change management associated with the service-oriented architecture, readiness of at least one process and business service associated with the service-oriented architecture, and risk management and mitigation associated with the service-oriented architecture;
wherein the first information system is selected as the more efficient information system for implementation in the service-oriented architecture based on the first information system obtaining a higher rank in the at least one criteria than a rank obtained by the second information system in the at least one criteria.

7. The method according to claim 6, wherein the ranking further comprises
ranking and classifying at least one error generated by the at least one of the first and second information systems.

8. A computer program product comprising a machine-readable medium storing instructions that, when executed by at least one programmable processor, cause the at least one programmable processor to perform operations comprising:
generating a service-oriented architecture containing a first information system for implementation in an enterprise system;
analyzing efficiency of the first information system by comparing the efficiency of the first information system with efficiency of a second information system, wherein the second information system is associated with the service-oriented architecture and performs at least one function performed by the first information system; and
selecting, based on analyzing, a more efficient information system for implementation in the service-oriented information system.

9. The computer program product according to claim 8, wherein the generating further comprises
analyzing enterprise architecture by assessing business capabilities, business processes, and application capabilities of the enterprise;
identifying at least one business service;
identifying at least one technical service; and
designing, based on the analyzing and identifying of the at least one business service and the at least one technical service, the service-oriented strategy.

10. The computer program product according to claim 9, wherein the identifying the at least one business service further comprises
analyzing business service requirement attributes;
identifying a list of business services containing the at least one identified business service;
designing a service map of business services in the identified list of business services; and
identifying at least one business object for use in the at least one business service.

11. The computer program product according to claim 9, wherein the identifying the at least one technical service further comprises
performing discovery of the at least one technical service;
designing the at least one technical service; and
documenting the at least one technical service.

12. The computer program product according to claim 9, wherein the designing of the service oriented strategy further comprises generating documentation describing implementation of service-oriented architecture based on a map of business services.

13. The computer program product according to claim 8, wherein the analyzing further comprises
ranking the first information system using at least one criteria selected from at least one group of criteria;
wherein the at least one criteria in the at least one group of criteria includes at least one of the following: internal work and organization of the first information system, at least one policy of the service-oriented architecture, guidelines and change management associated with the service-oriented architecture, readiness of at least one process and business service associated with the service-oriented architecture, and risk management and mitigation associated with the service-oriented architecture;
wherein the first information system is selected as the more efficient information system for implementation in the service-oriented architecture based on the first information system obtaining a higher rank in the at least one criteria than a rank obtained by the second information system in the at least one criteria.

14. The computer program product according to claim 13, wherein the ranking further comprises
ranking and classifying at least one error generated by the at least one of the first and second information systems.

15. A system comprising:
at least one programmable processor; and
a machine-readable medium storing instructions that, when executed by the at least one programmable processor, cause the at least one programmable processor to perform operations comprising:
generating a service-oriented architecture containing a first information system for implementation in an enterprise system;
analyzing efficiency of the first information system by comparing the efficiency of the first information system with efficiency of a second information system, wherein the second information system is associated with the service-oriented architecture and performs at least one function performed by the first information system; and
selecting, based on analyzing, a more efficient information system for implementation in the service-oriented information system.

16. The system according to claim 15, wherein the generating further comprises
analyzing enterprise architecture by assessing business capabilities, business processes, and application capabilities of the enterprise;
identifying at least one business service;
identifying at least one technical service; and
designing, based on the analyzing and identifying of the at least one business service and the at least one technical service, the service-oriented strategy.

17. The system according to claim 16, wherein the identifying the at least one business service further comprises
analyzing business service requirement attributes;
identifying a list of business services containing the at least one identified business service;
designing a service map of business services in the identified list of business services; and
identifying at least one business object for use in the at least one business service.

18. The system according to claim 16, wherein the identifying the at least one technical service further comprises
performing discovery of the at least one technical service;
designing the at least one technical service; and
documenting the at least one technical service.

19. The system according to claim 15, wherein the analyzing further comprises
ranking the first information system using at least one criteria selected from at least one group of criteria;
wherein the at least one criteria in the at least one group of criteria includes at least one of the following: internal work and organization of the first information system, at least one policy of the service-oriented architecture, guidelines and change management associated with the service-oriented architecture, readiness of at least one process and business service associated with the service-oriented architecture, and risk management and mitigation associated with the service-oriented architecture;
wherein the first information system is selected as the more efficient information system for implementation in the service-oriented architecture based on the first information system obtaining a higher rank in the at least one criteria than a rank obtained by the second information system in the at least one criteria.

20. The system according to claim 19, wherein the ranking further comprises ranking and classifying at least one error generated by the at least one of the first and second information systems.
